(19) United States
(12) Patent Application Publication
(10) Pub. No.: US 2025/0214836 A1
(43) Pub. Date: Jul. 3, 2025

(54) H2 RECOVERY AND CO2 SEPARATION USING MEMBRANE

(71) Applicant: Saudi Arabian Oil Company, Dhahran (SA)

(72) Inventors: Ahmed W. Ameen, Dhahran (SA); Mohammad Saad AlQahtani, Dhahran (SA); Seung-Hak Choi, Incheon (KR); Faisal Abdulrahman Almulhim, Al Hufuf (SA)

(21) Appl. No.: 18/402,277

(22) Filed: Jan. 2, 2024

(51) Int. Cl. C01B 3/56; B01D 53/047

(52) U.S. Cl. CPC C01B 3/56; B01D 53/047; B01D 2256/16; B01D 2257/504; B01D 2317/025; C01B 2210/001; C01B 2210/0051

(57) ABSTRACT

A method of treating a gas stream that includes: performing a first pressure swing adsorption (PSA) process generating a first H₂-product gas and a first PSA tail gas from a first feed gas, the first PSA tail gas including a residual H₂ and CO₂; separating CO₂ from the first PSA tail gas using a CO₂ selective membrane, generating a CO₂-rich permeate gas and a CO₂-lean rejected gas; performing a second PSA process generating a second H₂-product gas and a second PSA tail gas from a second feed gas, the second PSA tail gas including another residual H₂; mixing the CO₂-lean rejected gas and the second PSA tail gas to generate a mixed tail gas; and separating the residual H₂ and the another residual H₂ from the mixed tail gas using an H₂ selective membrane, generating a recovered H₂ permeate gas and a final rejected gas.

### TECHNICAL FIELD

This disclosure relates to methods and systems of processing, particularly to hydrogen (H₂) recovery and carbon dioxide (CO₂) separation using a membrane process.

### BACKGROUND

Hydrogen (H₂) is an industrially important feedstock and chemical critical to various chemical and refinery processes such as ammonia production, aromatization, hydrodesulfurization, and the hydrogenation or hydrocracking of hydrocarbons. H₂ is commercially produced, for example, through reforming of hydrocarbons in refineries. Hydrogen can also be produced by coal gasification, biomass gasification, water electrolysis, or the reforming or partial oxidation of natural gas or other hydrocarbons.

The reforming of natural gas is the most prevalent source of hydrogen production. Bulk hydrogen is typically produced by the steam reforming of natural gas, e.g., methane. Conventional steam reforming includes heating the natural gas in the presence of steam and a nickel catalyst. This endothermic reaction generates carbon monoxide and hydrogen. The carbon monoxide gas can be subjected to a water-gas shift reaction to obtain additional hydrogen, generating carbon dioxide (CO₂) as a by-product. Accordingly, H₂ purification and CO₂ separation from the gas stream is essential steps of a commercial H₂ production process.

### SUMMARY

An embodiment described herein provides a method of treating a gas stream, where the method includes: performing a first pressure swing adsorption (PSA) process generating a first H₂-product gas and a first PSA tail gas from a first feed gas, the first PSA tail gas including a residual H₂ and CO₂; separating CO₂ from the first PSA tail gas using a CO₂ selective membrane, generating a CO₂-rich permeate gas and a CO₂-lean rejected gas; performing a second PSA process generating a second H₂-product gas and a second PSA tail gas from a second feed gas, the second PSA tail gas including another residual H₂; mixing the CO₂-lean rejected gas and the second PSA tail gas to generate a mixed tail gas; and separating the residual H₂ and the another residual H₂ from the mixed tail gas using an H₂ selective membrane, generating a recovered H₂ permeate gas and a final rejected gas.

An embodiment described herein provides a gas treatment system that includes: a first pressure swing adsorption (PSA) column to generate a first H₂-product gas and a first PSA tail gas from a first feed gas, the first PSA tail gas including CO₂ and a residual H₂; a CO₂ selective membrane, connected to the first PSA column and configured to separate CO₂ from the first PSA tail gas, generating a CO₂-rich permeate gas and a CO₂-lean rejected gas; a second PSA column to generate a second H₂-product gas and a second PSA tail gas from a second feed gas, the second PSA tail gas including another residual H₂; a tail gas mixer to mix the CO₂-lean rejected gas and the second PSA tail gas, generating a mixed tail gas; and an H₂ selective membrane to separate the residual H₂ and the another residual H₂ from the mixed tail gas using an H₂ selective membrane, generating a recovered H₂ permeate gas and a final rejected gas.

An embodiment described herein provides an H₂ recovery system that includes: a steam reformer to generate a first feed gas including H₂ and CO₂, where a CO₂ concentration of the first feed gas is between 10% and 30%; a first pressure swing adsorption (PSA) column to generate a first H₂-product gas and a first PSA tail gas from the first feed gas, the first PSA tail gas including the CO₂ and a residual H₂; a CO₂ selective membrane, connected to the first PSA column and configured to separate CO₂ from the first PSA tail gas, generating a CO₂-rich permeate gas and a CO₂-lean rejected gas; an H₂ production facility to generate a second feed gas including H₂, where a CO₂ concentration of the second feed gas is less than 0.1%; a second PSA column to generate a second H₂-product gas and a second PSA tail gas from the second feed gas, the second PSA tail gas including another residual H₂; a tail gas mixer to mix the CO₂-lean rejected gas and the second PSA tail gas, generating a mixed tail gas; an H₂ selective membrane to separate the residual H₂ and the another residual H₂ from the mixed tail gas using an H₂ selective membrane, generating a recovered H₂ permeate gas and a final rejected gas; and a feed gas mixer to add the recovered H₂ permeate gas to the first feed gas.

### BRIEF DESCRIPTION OF DRAWINGS

FIG. 1 is a block diagram of a tail gas H₂ recovery system.

FIG. 2 is a block diagram of a tail gas H₂ recovery system with single-stage CO₂ separation.

FIG. 3 is a block diagram of a tail gas H₂ recovery system with two-stage CO₂ separation.

FIG. 4 is a block diagram of a tail gas H₂ recovery system with two-stage CO₂ separation.

FIG. 5 is an example process flow diagram of a method of tail gas H₂ recovery.

### DETAILED DESCRIPTION

Embodiments described herein provide methods and systems of H₂ recovery and CO₂ separation, particularly for residual H₂ recovery from multiple pressure swing adsorption (PSA) tail gases. Generally, H₂ in refinery is produced from reforming naphtha or hydrocarbon as an off-gas with H₂ concentration about 70-90%. The rest of gases in the off-gas are mainly hydrocarbons, e.g., un-converted feedstock, with traces of hydrogen sulfide (H₂S). H₂S in the off-gas is typically removed using H₂S selective absorption. The sweet off-gas after the H₂S removal can be then sent to a PSA unit to produce pure H₂. In the typical PSA unit, hydrocarbons are adsorbed using molecular sieves and other adsorbents while H₂ are passing through the adsorbent beds and exiting the process at concertation above 99%. Beside producing the pure H₂ stream, another stream as a PSA tail gas is produced during the desorption step. The PSA tail gas stream has H₂ content about 40-50% and used mostly as a fuel gas. It is therefore desired to recover the residual H₂ from the PSA tail gas to improve the overall H₂ production efficiency and yield. In many refineries, additional H₂ production is needed to meet its H₂ demand. For example, a steam reforming (SR) can be used in addition to H₂ recovery from the refinery off-gas. The SR product gas stream typically contains about 70% H₂, about 20% CO₂, and about 7% methane or other hydrocarbon, and about 3% carbon monoxide (CO). One common PSA column can be used to purify both the SR outlet and the refinery off-gas by mixing both the streams. Alternately, two PSA columns can be used to separately treat the two H₂-containing streams. This two-PSA process typically achieves about 85% H₂ recovery.

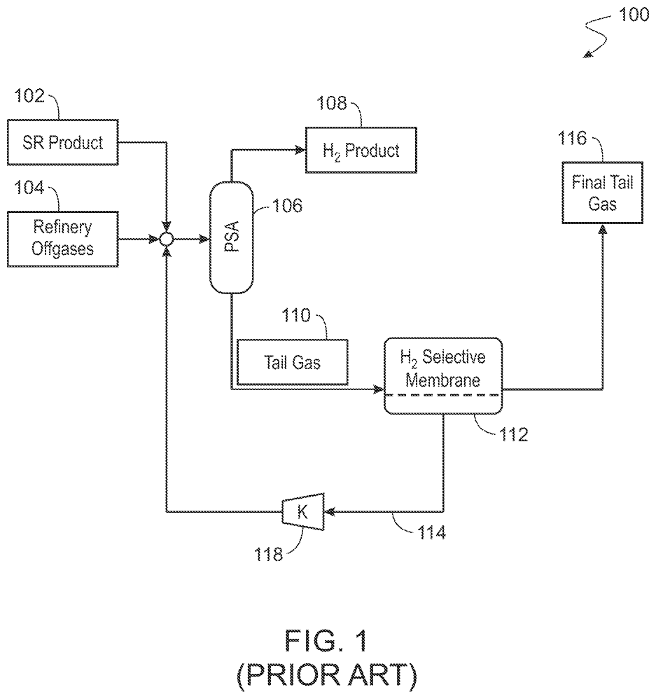

FIG. 1 is an example of a conventional tail gas H₂ recovery system 100. Solid arrows are used in FIG. 1 to indicate gas or liquid flows, e.g., inflow and outflow. Generally, to meet the pure H₂ demand, most refineries use multiple H₂ production routes, e.g., a refinery off-gas and steam reforming (SR). Pressure swing adsorption (PSA) processes may be employed to separate H₂ but some residual H₂ escapes in the tail gases. The residual H₂ may be recovered from the tail gases using an H₂ selective membrane. In FIG. 1, a steam reforming (SR) product gas 102 from a SR process, e.g., steam methane reforming (SMR) and a refinery off-gas 104 are combined and sent to a pressure swing adsorption (PSA) column 106 and separated into an H₂ product gas 108 and a tail gas 110. The tail gas 110 is then sent to an H₂ selective membrane 112 to form a recovered H₂-rich gas 114 and a final tail gas 116. The recovered H₂-rich gas 114 is sent to a recycle gas compressor 118 and then looped back to the PSA column 106 for improving the overall H₂ recovery. The final tail gas 116, as a retentate stream can be used as a fuel gas.

However, the enrichment rate of H₂ in the permeate stream of a membrane process in this conventional method can be limited due to the high CO₂ concentration in the tail gas 110. Various embodiments described in this disclosure can improve the overall H₂ recovery by employing (1) two PSA columns to separately recover H₂ from the two streams, and (2) a CO₂ selective membrane to first recover CO₂ from the first PSA tail gas, e.g., a CO₂-rich gas, before mixing it with the second PSA tail gas, e.g., a CO₂-free tail gas.

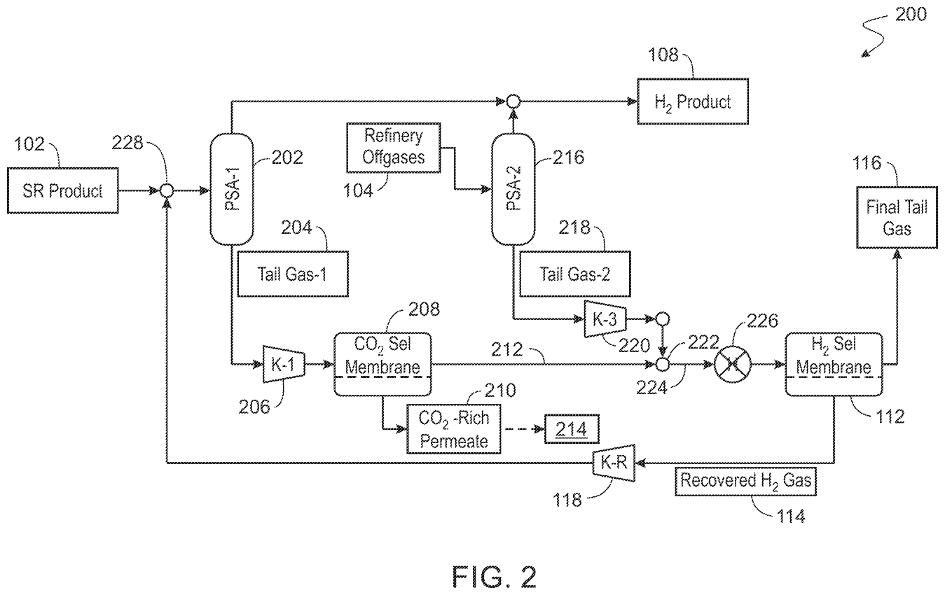

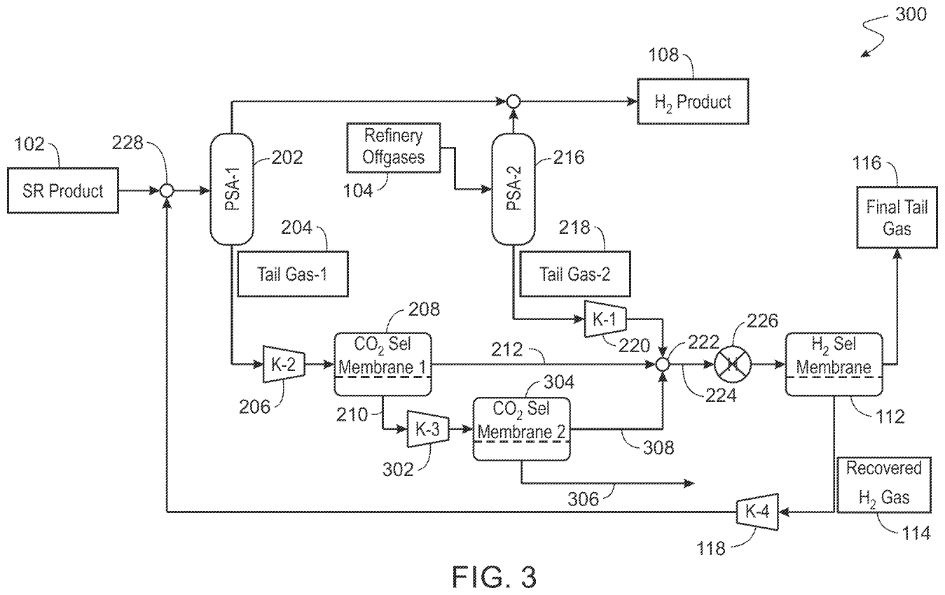

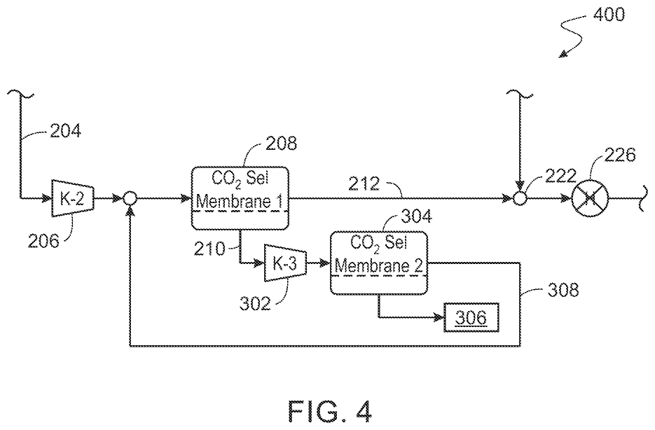

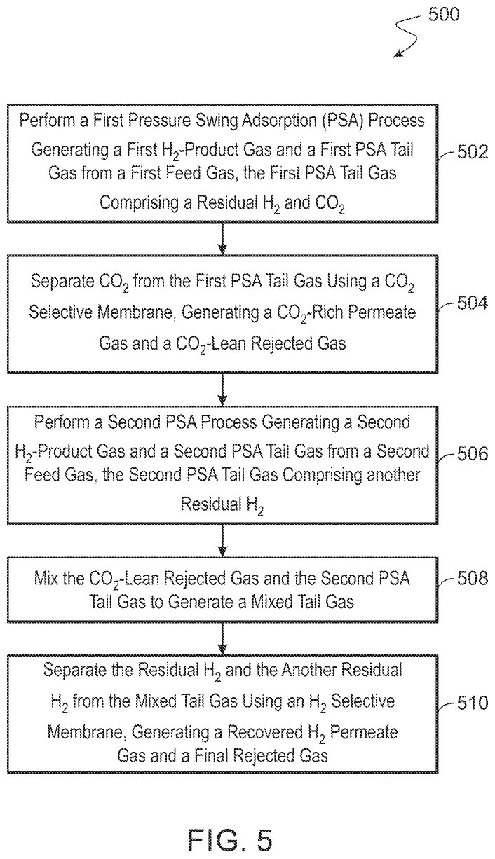

In the following, various embodiments of the methods and systems of H₂ recovery including separate tail gas treatment are described. Embodiments with one CO₂ selective membrane is first described referring to FIG. 2, and embodiments with two CO₂ selective membranes are then described referring to FIG. 3-4. FIG. 5 is an example process flow diagram. In this disclosure, unless otherwise noted, concentrations of gases components in a fluid are provided based on volumetric concentration in percentile, referred to as %.

### Single-Stage CO₂ Separation

FIG. 2 is an example of a tail gas H₂ recovery system 200 with single-stage CO₂ separation. In FIG. 2, unlike the conventional method described referring to FIG. 1, two H₂-containing gas streams are separately treated with two PSA columns to recover H₂. Each PSA yields a tail gas containing residual H₂, which can be recovered by the tail gas H₂ recovery system 200. The two tail gas compositions are different at least in the CO₂ concentration.

First, a steam reforming (SR) process, e.g., steam methane reforming (SMR), generates a SR product gas 102 containing H₂ and CO₂. Accordingly, in some embodiments, the tail gas H₂ recovery system 200 includes a steam reformer to generate the SR product gas 102. The SR process catalytically convert hydrocarbons such as methane, propane, or butane, to a syn-gas, a mixture of H₂ and CO. The SR process can include water-gas shift (WGS) reaction between CO and water (H₂O) to produce more H₂. CO₂ is thus generated as a by-product, making H₂ and CO₂ the main gas components of the SR product gas 102. In various embodiments, the SR product gas 102 contains about 10% to 30% CO₂, for example, about 20%. A first pressure swing adsorption (PSA) column 202 processes the SR product gas 102 and generates an H₂ product gas 108 and a first PSA tail gas 204. In some embodiments, the first PSA tail gas 204 contains about 30% to about 70% CO₂, for example, about 50%. The CO₂ concentration of the first PSA tail gas 204 can be greater than that of the SR product gas 102 as a result of the PSA process. The first PSA tail gas 204 is first processed for CO₂ recovery prior to mixing with another tail gas.

In various embodiments, as illustrated in FIG. 2, the first PSA tail gas 204 is sent to a first tail gas compressor 206 and then a first CO₂ selective membrane 208. In some embodiments, the first PSA tail gas 204 is compressed to have a pressure between about 2 bar (200 kPa) and about 20 bar (2,000 kPa), for example, at about 10 bar (1,000 kPa). The first tail gas compressor 206 can compress the first PSA tail gas 204 to optimize its pressure, e.g., about 10 bar, as a feed gas to the first CO₂ selective membrane 208. The first CO₂ selective membrane 208 can separate the first PSA tail gas 204 into a CO₂-rich permeate gas 210 and a CO₂-lean rejected gas 212. The first CO₂ selective membrane 208 can include polymer-based rubbery materials such as polyether-polyamide copolymers, e.g., Pebax® polymer, and polydimethylsiloxane (PDMS). In some embodiments, the tail gas H₂ recovery system 200 can include a fluid temperature control system to maintain the temperature of the first PSA tail gas 204, e.g., above its dew point to prevent condensation of a water vapor present in the first PSA tail gas 204. In some embodiments, the process temperature for CO₂ separation is between about 25° C. and 60° C. In one or more embodiments, the tail gas H₂ recovery system 200 can further include, prior to the first CO₂ selective membrane 208, an additional pretreatment unit such as heater and carbon bed and particle filter.

In some embodiments, the CO₂ concentration in the CO₂-rich permeate gas 210 can be about 70-75%, achieving about 95% CO₂ recovery from the first PSA tail gas 204. In some embodiments, the CO₂-rich permeate gas 210 can be sent to another purification system 214, e.g., a cryogenic distillation system, for further purification to produce a high purity CO₂ stream, e.g., >99% CO₂.

On the other hand, the residual H₂ of the first PSA tail gas 204 is concentrated in the CO₂-lean rejected gas 212. Further, other gas components, e.g., methane (CH₄), N₂, and the like, can also be concentrated in the CO₂-lean rejected gas 212.

Still referring to FIG. 2, a second PSA column 216 is used to separate a refinery off-gas 104 into the H₂ product gas 108 and a second PSA tail gas 218. Although not specifically illustrated in FIG. 2, the tail gas H₂ recovery system 200 includes an H₂ production facility to generate the refinery off-gas 104. Further, the refinery off-gas 104 can be processed in one or more upstream facilities for acid gas removal, e.g., H₂S and CO₂. For example, an amine-based stripper, e.g., a diglycolamine absorber (DGA) unit, can be used. With the acid removal, the refinery off-gas 104 becomes a so-called “sweetened” product stream. Accordingly, in various embodiments, the second PSA tail gas 218 is a CO₂-free gas. In this disclosure, a gas is considered CO₂-free if the CO₂ concentration is below 0.1%. The second PSA tail gas 218 is then compressed by a second tail gas compressor 220. In some embodiments, the second PSA tail gas 218 is compressed to have a pressure between about 2 bar (200 kPa) and about 20 bar (2,000 kPa), for example, at about 10 bar (1,000 kPa).

The CO₂-lean rejected gas 212 from the first CO₂ selective membrane 208 and the second PSA tail gas 218 from the second PSA column 216 can be mixed using a tail gas mixer 222 to form a mixed tail gas 224. The mixed tail gas 224 is then sent to a heater 226 and an H₂ selective membrane 112 to form a recovered H₂-rich gas 124 and a final tail gas 116. In various embodiments, the mixed tail gas 224 is heated to between about 60° C. and 200° C., for example, about 150° C. The H₂ selective membrane 112 can include a polymer-based membrane in a glassy form, or a dense protonic ceramic membrane based on a single-phase and mixed-phase perovskite-type oxidic protonic ceramic material.

In various embodiments, the recovered H₂-rich gas 114 is obtained as a permeate gas. The recovered H₂-rich gas 114 can be sent to a recycle gas compressor 118 and then looped back to be mixed using a feed gas mixer 228 with the SR product gas 102 for improving the overall H₂ recovery. In some embodiments, the recovered H₂-rich gas 114 is compressed to have a pressure at a same level of the SR product gas 102 that is being fed to the first PSA column 202, e.g., between about 2 bar (200 kPa) and about 40 bar (4,000 kPa), for example, at about 20 bar (2,000 kPa).

On the other hand, the final tail gas 116 is obtained as a rejected gas. The final tail gas 116 can contain about 30-50% of CH₄ or other hydrocarbons and 10-15% H₂. The final tail gas 116 can be used, for example, as a fuel gas, mixed with a sale gas stream, or recycled as an additive to a feed to the steam reforming (SR) process. In some embodiments, especially when the heating value is not sufficient for other applications, the final tail gas 116 can be sent to an amine-based CO₂ removal facility. By integrating the CO₂ separation as a part of H₂ recovery, the final tail gas 116 contains less CO₂ compared to the conventional methods, thereby improving its heating value.

In various embodiments, the tail gas H₂ recovery process with CO₂ separation can reduce the membrane area required for the H₂ selective membrane 112 compared to the conventional methods, thereby also reducing the overall capital expenditure for H₂ recovery

### Two-Stage CO₂ Separation

FIG. 3 is an example of a tail gas H₂ recovery system 300 with two-stage CO₂ separation. Like numbered items are as described with respect to FIG. 2 and will not be repeated in detail. In FIG. 3, the tail gas H₂ recovery system 300 uses two CO₂ selective membranes in series for two-stage CO₂ separation. The H₂ production stage can be identical to prior embodiments described referring to FIG. 2. An H₂ product gas 108 is obtained from each of a SR product gas 102 and a refinery off-gas 104 using a first PSA column 202 and a second PSA column 216, respectively. Further, the first PSA tail gas 204 is separated using a first CO₂ selective membrane 208 into a CO₂-rich permeate gas 210 and a CO₂-lean rejected gas 212.

Unlike the prior embodiments described referring to FIG. 2, in FIG. 3, the CO₂-rich permeate gas 210 is processed for further H₂ recovery. Using two CO₂ selective membranes, it is possible to further concentrate the CO₂ in the tail gas, e.g., the CO₂-rich permeate gas 210 while recovering more H₂ in the reject sides of both membranes. The CO₂-rich permeate gas 210 is sent to a third tail gas compressor 302 for compression and then to a second CO₂ selective membrane 304 that generates a second CO₂-rich permeate gas 306 and a second CO₂-lean rejected gas 308. In some embodiments, the second CO₂-rich permeate gas 306 contains about 90% CO₂. The second CO₂-lean rejected gas 308 and the CO₂-lean rejected gas 212 can be mixed using a tail gas mixer 222 with the second PSA tail gas 218 to form a mixed tail gas 224. The mixed tail gas 224 can be processed for H₂ recovery in the same way as described above referring to FIG. 2.

In various embodiments, the second CO₂ selective membrane 304 can include polymer-based rubbery materials such as polyether-polyamide copolymers, e.g., Pebax® polymer and polydimethylsiloxane (PDMS). In some embodiments, the second CO₂ selective membrane 304 can use the same membrane material as the first CO₂ selective membrane 208, but it is not necessary. The membrane area can be larger in the first CO₂ selective membrane 208 than the second CO₂ selective membrane 304. In some embodiments, the CO₂-rich permeate gas 210 after the first CO₂ separation has a pressure of about 1 bar (100 kPa), which can be compressed again using the third tail gas compressor 302 to have a pressure between about 2 bar (200 kPa) and about 20 bar (2,000 kPa), for example, at about 10 bar (1,000 kPa), prior to the second CO₂ separation. In one or more embodiments, the tail gas H₂ recovery system 300 can include one or more additional pretreatment units between the first CO₂ selective membrane 208 and the second CO₂ selective membrane 304.

FIG. 4 is an example of a part of a tail gas H₂ recovery system 400 with two-stage CO₂ separation. Like numbered items are as described with respect to FIGS. 2-3 and will not be repeated in detail. In FIG. 4, some components of the tail gas H₂ recovery system 400, e.g., PSA columns and H₂ selective membrane, are omitted for illustration purpose.

In FIG. 4, the second CO₂-lean rejected gas 308 is sent back to be added to a feed gas to the first CO₂ selective membrane 208. Accordingly, the second CO₂-lean rejected gas 308 is mixed with the first PSA tail gas 204 in FIG. 4 instead of mixing with the CO₂-lean rejected gas 212 as described in FIG. 3.

In FIG. 2-4, the recovered H₂-rich gas 114 is sent back to be mixed with the SR product gas 102 for improving the overall H₂ recovery and CO₂ capture. By this loop, any residual CO₂ in the recovered H₂-rich gas 114 can be subject to another cycle of CO₂ separation after the first PSA column 202. In some embodiments, although not specifically illustrated in FIGS. 2-4, the recovered H₂-rich gas 114 can instead be sent back and mixed with the refinery off-gas 104 to be treated with the second PSA column 216.

FIG. 5 is a process flow diagram of a method 500 of tail gas H₂ recovery. In FIG. 5, the method 500 starts with performing a first pressure swing adsorption (PSA) process 502 generating a first H₂-product gas and a first PSA tail gas from a first feed gas, where the first PSA tail gas includes a residual H₂ and CO₂. Subsequently, CO₂ is separated 504 from the first PSA tail gas using a CO₂ selective membrane, generating a CO₂-rich permeate gas and a CO₂-lean rejected gas. A second PSA process is performed 506 generating a second H₂-product gas and a second PSA tail gas from a second feed gas, where the second PSA tail gas includes another residual H₂. Next, the CO₂-lean rejected gas and the second PSA tail gas are mixed 508 to generate a mixed tail gas, followed by separating 510 H₂ in the mixed tail gas using an H₂ selective membrane, generating a recovered H₂ permeate gas and a final rejected gas.

### Examples

The H₂ recovery and CO₂ separation was simulated by Aspen HYSYS® V12 to examine its efficiency in an example of two tail gas treatment in accordance with an embodiment. Membrane unit was designed using the Saudi Aramco proprietary Industrial Membrane Process Simulator (IMPS) (External extension within HYSYS). Two feed gasses, a steam reforming (SR) product gas and a refinery off-gas, are first simulated for PSA processes. Table 1 summarizes the two feed gas compositions and the tail gas compositions after the PSA processes. It was confirmed that both tail gases 1 and 2 still contain residual H₂ at 26% and 42%, respectively, after the PSA processes. Further, the tail gas 1 contains 47% CO₂ while the tail gas 2 does not contain any CO₂.

TABLE 1
Aspen HYSYS ® simulation results for PSA process.

| | | | | Tail gas 2 |
|---|---|---|---|---|
| | SR product | Refinery | Tail gas 1 | (from |
| | gas | off-gas | (from SR) | off-gas) |
| Temp. (° F.) | 105.0 | 105.0 | 101.4 | 102.9 |
| Press. (bar) | 20.0 | 20.0 | 1.5 | 1.5 |
| Molar flow (lb-mole/h) | 1.0 × 10⁴ | 1.0 × 10⁴ | 4341.5 | 2603.5 |
| Mass flow (ton/day) | 1326.0 | 708.1 | 1251.1 | 545.3 |
| H₂ (%) | 70.00 | 85.00 | 26.34 | 42.4 |
| CO (%) | 3.00 | 0.00 | 7.05 | 0.00 |
| CO₂ (%) | 20.00 | 0.00 | 47.32 | 0.00 |
| CH₄ (%) | 6.80 | 5.00 | 18.65 | 19.19 |
| C₂H₆ (%) | 0.00 | 5.00 | 0.13 | 19.19 |
| C₃H₈ (%) | 0.00 | 3.00 | 0.04 | 11.51 |
| C₄H₁₀ (%) | 0.00 | 2.00 | 0.01 | 7.67 |
| H₂O (%) | 0.20 | 0.00 | 0.46 | 0.00 |

Further, the H₂ recovery and CO₂ separation from these tail gases using two-stage CO₂ separation were simulated. Membrane permeance used in the simulation and the result of the simulation are summarized in Tables 2 and 3, respectively. The CO₂ separation from the tail 1 using two CO₂ selective membranes was simulated at following process conditions: temperature at 105° F. (40.6° C.) and pressure at 10.0 bar. The first permeated gas (permeate CO₂-1) is sent to the second CO₂ selective membrane. The rejected gases from the two CO₂ selective membranes (rejected CO₂-1 and rejected CO₂-2) are combined for the subsequent H₂ separation using an H₂ selective membrane simulated at a temperature of 300° F. (148.9° C.) and a pressure of 10 bar. The residual H₂ present in the two tail gases is recovered as the permeate gas. The unrecovered H₂ is 6.8% H₂ in the final CO₂ permeate (permeate CO₂-2 in Table 3) and 10.7% H₂ in the rejected gas after the H₂ separation. Based on the initial volume of H₂ in the two feed gases, the PSA processes followed by the tail gas H₂ recovery yielded about 97% H₂ recovery. The use of this tail gas H₂ recovery process improved the H₂ recovery from about 85%. On the other hand, the CO₂ in the tail gas 1 is recovered as the final CO₂ permeate (permeate CO₂-2 in Table 3). A high concentration of about 90% CO₂ is obtained, and more than 85% of CO₂ is recovered. Consequently, the final tail gas contains about 38% methane and only about 8% CO₂, this tail gas has a heating value greater than a tail gas from a conventional process.

TABLE 2
Membrane permeance used in Aspen HYSYS ® simulation.

| | CO₂ selective membrane | H₂ selective membrane |
|---|---|---|
| | (GPU) | (GPU) |
| H₂ | 37.5 | 300 |
| N₂ | 10 | 10 |
| CO | 20 | 2 |
| CO₂ | 300 | 30 |
| CH₄ | 20 | 10 |
| C₂H₆ | 50 | 1 |

TABLE 3
Aspen HYSYS ® simulation results for tail gas
H₂ recovery using two-stage CO₂ separation.

| | Rejected | Permeate | Rejected | Permeate | Rejected | Permeate |
|---|---|---|---|---|---|---|
| | CO₂-1 | CO₂-1 | CO₂-2 | CO₂-2 | H₂ | H₂ |
| Temp. (° F.) | 105.0 | 105.0 | 105.0 | 105.0 | 300.0 | 300.0 |
| Press. (bar) | 10.0 | 1.0 | 10.0 | 1.0 | 10.0 | 1.0 |
| Molar flow | 1860.6 | 2480.9 | 521.7 | 1959.2 | 2991.3 | 1994.4 |
| (lb-mole/h) | | | | | | |
| Mass flow | 299.5 | 951.5 | 92.0 | 859.5 | 842.9 | 93.3 |
| (ton/day) | | | | | | |
| H₂ (%) | 41.20 | 15.18 | 46.65 | 6.81 | 10.74 | 89.94 |
| CO (%) | 13.21 | 2.43 | 9.10 | 0.65 | 9.59 | 0.32 |
| CO₂ (%) | 10.41 | 75.01 | 19.85 | 89.69 | 8.06 | 2.82 |
| CH₄ (%) | 34.96 | 6.42 | 24.08 | 1.71 | 38.29 | 6.52 |
| C₂H₆ (%) | 0.18 | 0.09 | 0.24 | 0.05 | 16.66 | 0.28 |
| C₃H₈ (%) | 0.03 | 0.05 | 0.06 | 0.04 | 9.99 | 0.08 |
| C₄H₁₀ (%) | 0.00 | 0.02 | 0.00 | 0.02 | 6.66 | 0.03 |
| H₂O (%) | 0.01 | 0.81 | 0.01 | 1.02 | 0.00 | 0.01 |

### Embodiments

An embodiment described herein provides a method of treating a gas stream, where the method includes: performing a first pressure swing adsorption (PSA) process generating a first H₂-product gas and a first PSA tail gas from a first feed gas, the first PSA tail gas including a residual H₂ and CO₂; separating CO₂ from the first PSA tail gas using a CO₂ selective membrane, generating a CO₂-rich permeate gas and a CO₂-lean rejected gas; performing a second PSA process generating a second H₂-product gas and a second PSA tail gas from a second feed gas, the second PSA tail gas including another residual H₂; mixing the CO₂-lean rejected gas and the second PSA tail gas to generate a mixed tail gas; and separating the residual H₂ and the another residual H₂ from the mixed tail gas using an H₂ selective membrane, generating a recovered H₂ permeate gas and a final rejected gas.

In an aspect, combinable with any other aspect, the method further includes mixing the recovered H₂ permeate gas with the first feed gas.

In an aspect, combinable with any other aspect, the method further includes compressing the first PSA tail gas prior to separating the CO₂ from the first PSA tail gas.

In an aspect, combinable with any other aspect, the method further includes passing the CO₂-rich permeate gas through another CO₂ selective membrane, generating another CO₂-rich permeate gas and another CO₂-lean rejected gas.

In an aspect, combinable with any other aspect, the method further includes compressing the CO₂-rich permeate gas prior to passing the CO₂-rich permeate gas through the another CO₂ selective membrane.

In an aspect, combinable with any other aspect, the method further includes adding the another CO₂-lean rejected gas to the mixed tail gas prior to separating the H₂ from the mixed tail gas.

In an aspect, combinable with any other aspect, the method further includes adding the another CO₂-lean rejected gas to the first PSA tail gas or the second PSA tail gas.

In an aspect, combinable with any other aspect, the method further includes performing a steam reforming, generating the first feed gas.

In an aspect, combinable with any other aspect, a CO₂ concentration of the first feed gas is between 10% and 30%.

In an aspect, combinable with any other aspect, a CO₂ concentration of the second feed gas is 0.1% or less.

An embodiment described herein provides a gas treatment system that includes: a first pressure swing adsorption (PSA) column to generate a first H₂-product gas and a first PSA tail gas from a first feed gas, the first PSA tail gas including CO₂ and a residual H₂; a CO₂ selective membrane, connected to the first PSA column and configured to separate CO₂ from the first PSA tail gas, generating a CO₂-rich permeate gas and a CO₂-lean rejected gas; a second PSA column to generate a second H₂-product gas and a second PSA tail gas from a second feed gas, the second PSA tail gas including another residual H₂; a tail gas mixer to mix the CO₂-lean rejected gas and the second PSA tail gas, generating a mixed tail gas; and an H₂ selective membrane to separate the residual H₂ and the another residual H₂ from the mixed tail gas using an H₂ selective membrane, generating a recovered H₂ permeate gas and a final rejected gas.

In an aspect, combinable with any other aspect, the gas treatment system further includes: a first compressor between the first PSA column and the CO₂ selective membrane; and a second compressor between the second PSA column and the H₂ selective membrane.

In an aspect, combinable with any other aspect, the gas treatment system further includes: another CO₂ selective membrane to receive the CO₂-rich permeate gas from the CO₂ selective membrane, generating another CO₂-rich permeate gas and another CO₂-lean rejected gas; and a third compressor between the CO₂ selective membrane and the another CO₂ selective membrane.

In an aspect, combinable with any other aspect, the tail gas mixer is configured to add the another CO₂-lean rejected gas to the mixed tail gas.

In an aspect, combinable with any other aspect, the gas treatment system further includes a CO₂ mixer between the first PSA column and the CO₂ selective membrane, where the CO₂ mixer is configured to add the another CO₂-lean rejected gas to the first PSA tail gas.

In an aspect, combinable with any other aspect, the gas treatment system further includes a heater to heat the mixed tail gas, where the heater is between the mixer and the H₂ selective membrane.

In an aspect, combinable with any other aspect, the gas treatment system further includes a feed mixer to add the recovered H₂ permeate gas to the first feed gas.

An embodiment described herein provides an H₂ recovery system that includes: a steam reformer to generate a first feed gas including H₂ and CO₂, where a CO₂ concentration of the first feed gas is between 10% and 30%; a first pressure swing adsorption (PSA) column to generate a first H₂-product gas and a first PSA tail gas from the first feed gas, the first PSA tail gas including the CO₂ and a residual H₂; a CO₂ selective membrane, connected to the first PSA column and configured to separate CO₂ from the first PSA tail gas, generating a CO₂-rich permeate gas and a CO₂-lean rejected gas; an H₂ production facility to generate a second feed gas including H₂, where a CO₂ concentration of the second feed gas is less than 0.1%; a second PSA column to generate a second H₂-product gas and a second PSA tail gas from the second feed gas, the second PSA tail gas including another residual H₂; a tail gas mixer to mix the CO₂-lean rejected gas and the second PSA tail gas, generating a mixed tail gas; an H₂ selective membrane to separate the residual H₂ and the another residual H₂ from the mixed tail gas using an H₂ selective membrane, generating a recovered H₂ permeate gas and a final rejected gas; and a feed gas mixer to add the recovered H₂ permeate gas to the first feed gas.

In an aspect, combinable with any other aspect, the H₂ recovery system further includes another CO₂ selective membrane to receive the CO₂-rich permeate gas from the CO₂ selective membrane, generating another CO₂-rich permeate gas and another CO₂-lean rejected gas.

In an aspect, combinable with any other aspect, the H₂ recovery system further includes a cryogenic distillation system to purify the another CO₂-rich permeate gas from the another CO₂ selective membrane.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method of treating a gas stream, the method comprising:
performing a first pressure swing adsorption (PSA) process generating a first H₂-product gas and a first PSA tail gas from a first feed gas, the first PSA tail gas comprising a residual H₂ and CO₂;
separating CO₂ from the first PSA tail gas using a CO₂ selective membrane, generating a CO₂-rich permeate gas and a CO₂-lean rejected gas;
performing a second PSA process generating a second H₂-product gas and a second PSA tail gas from a second feed gas, the second PSA tail gas comprising another residual H₂;
mixing the CO₂-lean rejected gas and the second PSA tail gas to generate a mixed tail gas; and
separating the residual H₂ and the another residual H₂ from the mixed tail gas using an H₂ selective membrane, generating a recovered H₂ permeate gas and a final rejected gas.

2. The method of claim 1, further comprising mixing the recovered H₂ permeate gas with the first feed gas.

3. The method of claim 1, further comprising compressing the first PSA tail gas prior to separating the CO₂ from the first PSA tail gas.

4. The method of claim 1, further comprising passing the CO₂-rich permeate gas through another CO₂ selective membrane, generating another CO₂-rich permeate gas and another CO₂-lean rejected gas.

5. The method of claim 4, further comprising compressing the CO₂-rich permeate gas prior to passing the CO₂-rich permeate gas through the another CO₂ selective membrane.

6. The method of claim 4, further comprising adding the another CO₂-lean rejected gas to the mixed tail gas prior to separating the H₂ from the mixed tail gas.

7. The method of claim 4, further comprising adding the another CO₂-lean rejected gas to the first PSA tail gas or the second PSA tail gas.

8. The method of claim 1, further comprising performing a steam reforming, generating the first feed gas.

9. The method of claim 1, wherein a CO₂ concentration of the first feed gas is between 10% and 30%.

10. The method of claim 1, wherein a CO₂ concentration of the second feed gas is 0.1% or less.

11. A gas treatment system comprising:
a first pressure swing adsorption (PSA) column to generate a first H₂-product gas and a first PSA tail gas from a first feed gas, the first PSA tail gas comprising CO₂ and a residual H₂;
a CO₂ selective membrane, connected to the first PSA column and configured to separate CO₂ from the first PSA tail gas, generating a CO₂-rich permeate gas and a CO₂-lean rejected gas;
a second PSA column to generate a second H₂-product gas and a second PSA tail gas from a second feed gas, the second PSA tail gas comprising another residual H₂;
a tail gas mixer to mix the CO₂-lean rejected gas and the second PSA tail gas, generating a mixed tail gas; and
an H₂ selective membrane to separate the residual H₂ and the another residual H₂ from the mixed tail gas using an H₂ selective membrane, generating a recovered H₂ permeate gas and a final rejected gas.

12. The gas treatment system of claim 11, further comprising:
a first compressor between the first PSA column and the CO₂ selective membrane; and
a second compressor between the second PSA column and the H₂ selective membrane.

13. The gas treatment system of claim 11, further comprising:
another CO₂ selective membrane to receive the CO₂-rich permeate gas from the CO₂ selective membrane, generating another CO₂-rich permeate gas and another CO₂-lean rejected gas; and
a third compressor between the CO₂ selective membrane and the another CO₂ selective membrane.

14. The gas treatment system of claim 13, wherein the tail gas mixer is configured to add the another CO₂-lean rejected gas to the mixed tail gas.

15. The gas treatment system of claim 13, further comprising a CO₂ mixer between the first PSA column and the CO₂ selective membrane, the CO₂ mixer configured to add the another CO₂-lean rejected gas to the first PSA tail gas.

16. The gas treatment system of claim 11, further comprising a heater to heat the mixed tail gas, the heater being between the mixer and the H₂ selective membrane.

17. The gas treatment system of claim 11, further comprising a feed mixer to add the recovered H₂ permeate gas to the first feed gas.

18. An H₂ recovery system comprising:
a steam reformer to generate a first feed gas comprising H₂ and CO₂, wherein a CO₂ concentration of the first feed gas is between 10% and 30%;
a first pressure swing adsorption (PSA) column to generate a first H₂-product gas and a first PSA tail gas from the first feed gas, the first PSA tail gas comprising the CO₂ and a residual H₂;
a CO₂ selective membrane, connected to the first PSA column and configured to separate CO₂ from the first PSA tail gas, generating a CO₂-rich permeate gas and a CO₂-lean rejected gas;
an H₂ production facility to generate a second feed gas comprising H₂, wherein a CO₂ concentration of the second feed gas is less than 0.1%;
a second PSA column to generate a second H₂-product gas and a second PSA tail gas from the second feed gas, the second PSA tail gas comprising another residual H₂;
a tail gas mixer to mix the CO₂-lean rejected gas and the second PSA tail gas, generating a mixed tail gas;
an H₂ selective membrane to separate the residual H₂ and the another residual H₂ from the mixed tail gas using an H₂ selective membrane, generating a recovered H₂ permeate gas and a final rejected gas; and
a feed gas mixer to add the recovered H₂ permeate gas to the first feed gas.

19. The H₂ recovery system of claim 18, further comprising another CO₂ selective membrane to receive the CO₂-rich permeate gas from the CO₂ selective membrane, generating another CO₂-rich permeate gas and another CO₂-lean rejected gas.

20. The H₂ recovery system of claim 19, further comprising a cryogenic distillation system to purify the another CO₂-rich permeate gas from the another CO₂ selective membrane.
